(19) United States
(12) Patent Application Publication
(10) Pub. No.: US 2026/0343336 A1
(43) Pub. Date: Oct. 29, 2026

(54) Quality of Experience (QoE) Continuity During Handover

(71) Applicant: Apple Inc., Cupertino, CA (US)

(72) Inventors: Fangli XU, Beijing (CN); Haijing HU, Los Gatos, CA (US); Peng CHENG, Beijing (CN); Ping-Heng KUO, London (GB); Ralf ROSSBACH, Munich (DE); Yuqin CHEN, Beijing (CN)

(21) Appl. No.: 19/116,208

(22) PCT Filed: Sep. 29, 2022
(86) PCT No.: PCT/CN2022/122871

§ 371 Date: Mar. 27, 2025

(51) Int. Cl. H04W 36/00

(52) U.S. Cl. CPC H04W 36/0058; H04W 36/0072

(57) ABSTRACT

system inter-radio access technology (inter-RAT) handover. The base station communicates with a user equipment (UE) using a first RAT. The base station configures the UE with a quality of experience (QoE) configuration indicating QoE measurements and QoE reporting for the first RAT, sends, to a target base station, a handover request comprising a QoE measurement configuration (QMC) configuration information element comprising the QoE configuration, wherein the target base station communicates with the UE using a second RAT, receives a handover acknowledgement indicating the UE is to continue the QoE measurements reporting for the second RAT after a handover from the source to target base station is performed and sends, to the UE, a handover command comprising an indication the UE is to continue the QoE measurements and QoE reporting for the second RAT after the handover.

### BACKGROUND

In 5G NR, Quality of Experience (QoE) management may be implemented to ensure an adequate user perceived quality of experience when using certain services. For example, 5G NR QoE measurement mechanisms may collect experience parameters for services such as, but not limited to, enhanced mobile broadband (eMBB), ultra-reliable low latency communication (URLLC), streaming, multimedia telephony service over IMS (MTSI), multimedia broadcast multicast services (MBMS), extended reality (XR), virtual reality (VR), etc. 5G NR QoE management may also include mechanisms for activation, deactivation, configuration, mobility support and reporting QoE measurements.

### SUMMARY

Some exemplary embodiments are related to a method performed by a base station operating as a source base station in an intra-system inter-radio access technology (inter-RAT) handover, wherein the base station communicates with a user equipment (UE) using a first RAT. The method includes configuring the UE with a quality of experience (QoE) configuration indicating QoE measurements and QoE reporting for the first RAT, sending, to a target base station of a second RAT, a handover request for the UE, wherein the handover request comprises a QoE measurement configuration (QMC) configuration information element (IE) comprising the QoE configuration, receiving, from the target base station, a handover acknowledgement indicating the UE is to continue the QoE measurements and QoE reporting for the second RAT to the target base station after a handover from the source base station to the target base station is performed and sending, to the UE, a handover command comprising an indication the UE is to continue the QoE measurements and QoE reporting for the second RAT after the handover.

Other exemplary embodiments are related to a method performed by a base station operating as a target base station in an intra-system inter-radio access technology (inter-RAT) handover, wherein the base station communicates with a user equipment (UE) using a first RAT. The method includes receiving, from a source base station, a handover request for the UE, wherein the handover request comprises a QoE measurement configuration (QMC) configuration information element (IE) comprising a QoE configuration, wherein the source base station communicates with the UE using a second RAT, and sending, to the source base station, a handover acknowledgement indicating the UE is to continue QoE measurements and QoE reporting for the first RAT to the target base station after a handover from the source base station to the target base station is performed.

Additional exemplary embodiments are related to a method performed by a user equipment (UE). The method includes receiving, from a source base station of a first radio access technology (RAT), a quality of experience (QoE) configuration indicating QoE measurements and QoE reporting for the first RAT, receiving, from the first base station, a handover command comprising an indication of a target base station of a second RAT to which the UE is to be handed over and that the UE is to continue the QoE measurements and QoE reporting for the second RAT after the handover, sending, to the target base station, a handover complete message indicating the handover from the source base station to the target base station is complete, performing QoE measurements for the second RAT and reporting the QoE measurements to the target base station.

### BRIEF DESCRIPTION OF THE DRAWINGS

FIG. 1 shows an exemplary network arrangement according to various exemplary embodiments.

FIG. 2 shows a further detailed view of an exemplary network arrangement according to various exemplary embodiments.

FIG. 3 shows an exemplary UE according to various exemplary embodiments.

FIG. 4 shows an exemplary UE according to various exemplary embodiments.

FIG. 5 shows an exemplary call flow for an intra-system inter-radio access technology (inter-RAT) RAT handover with QoE continuity according to various exemplary embodiments.

FIG. 6A shows an example call flow for a source node and target node to exchange inter-RAT QoE measurement configuration (QMC) continuity capabilities during node setup according to various exemplary embodiments.

FIG. 6B shows an example call flow for a source node and target node to exchange handover information related to inter-RAT QMC continuity capabilities according to various exemplary embodiments.

FIG. 6C shows an example call flow for a source node and target node to receive an Operations, Administration and Maintenance (OAM) configuration related to inter-RAT QMC continuity capabilities according to various exemplary embodiments.

FIG. 7 shows an exemplary call flow for an intra-system inter-RAT handover where both RATs have a compatible Uu radio resource control (RRC) design for QMC continuity capabilities according to various exemplary embodiments.

FIG. 8 shows an exemplary call flow for an intra-system New Radio (NR) to Long Term Evolution (LTE) handover where the RATs do not have a compatible Uu radio resource control (RRC) design for QMC continuity capabilities according to various exemplary embodiments.

### DETAILED DESCRIPTION

The exemplary embodiments may be further understood with reference to the following description and the related appended drawings, wherein like elements are provided with the same reference numerals. The exemplary embodiments are related to supporting quality of experience (QoE) continuity during intra-Fifth Generation Core (intra-5GC) inter-Radio Access Technology (inter-RAT) handover.

The exemplary embodiments are described with regard to operations performed by a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate electronic component that is capable of being handed over in an intra-5GC inter-RAT handover procedure.

In addition, as described above, the exemplary embodiments are described with reference to a intra-5GC inter-RAT handover. Those skilled in the art will understand that this typically means a handover from a 5G NR cell to a Long Term Evolution (LTE) cell (or vice versa) that are both connected to the 5GC. However, it should be understood that the exemplary embodiments may be extended to other types of handovers. For example, as the cellular standards evolve there may be further evolutions of cellular networks (e.g., 6G) including 6G core networks that are connected to 6G cells, 5G cells and/or LTE cells. The exemplary embodiments may, for example, also be applied to intra-6G inter-RAT handovers. Thus, the handover may be referred to more generically as an intra-system inter-RAT handover.

Throughout this description, various inter-rat handovers are described, e.g., LTE to NR or NR to LTE handovers. It should be understood that any description of a particular type of inter-RAT handover in the exemplary embodiments applies equally to other types of inter-RAT handovers unless specifically described as not applying. For example, a description of an LTE to NR handover in the exemplary embodiments would apply equally to an NR to LTE handover.

Throughout this description the terms QoE configuration and QoE measurement configuration (QMC configuration) may be used interchangeably. Generally, a QoE configuration includes the QoE measurements that a UE is to perform and an indication of the type of QoE reporting that the UE is to perform. Generally, the OMC configuration comprises one or more QoE configurations, e.g., the UE may be configured with a single QoE configuration or multiple QoE configurations.

As described above, QUE management may be implemented to ensure an adequate user perceived quality of experience when using certain multimedia services. However, it should be understood that QoE is not limited to multimedia services. This may include QoE measurement mechanisms to collect experience parameters for various services. The QoE measurement reporting may include sending application layer measurement reports to the network. In NR, a UE capable of application layer measurement reporting in RRC CONNECTED mode may initiate the procedure when configured with an appLayerMeasConfig IE in an RRC message. The UE may indicate its capability to support NR QoE in a 5G mobility management (5GMM) capability IE in a REGISTRATION REQUEST message. The network may indicate its support of 5G NR QoE in a 5G system (5GS) network feature support IE in a REGISTRATION ACCEPT message. The manner of configuring the UE to perform the QoE in LTE is generally the same, except that the names of the IEs may be different.

Currently, QoE measurement collection and reporting continuity is only supported for intra-system intra-RAT mobility in RRC connected mode. The exemplary embodiments extend this support to intra-system inter-RAT handovers. However, as will be described in greater detail below, there are several issues related to inter-RAT handovers that are not present for intra-RAT handovers. Thus, the exemplary embodiments include solutions for these issues to implement the inter-RAT handovers.

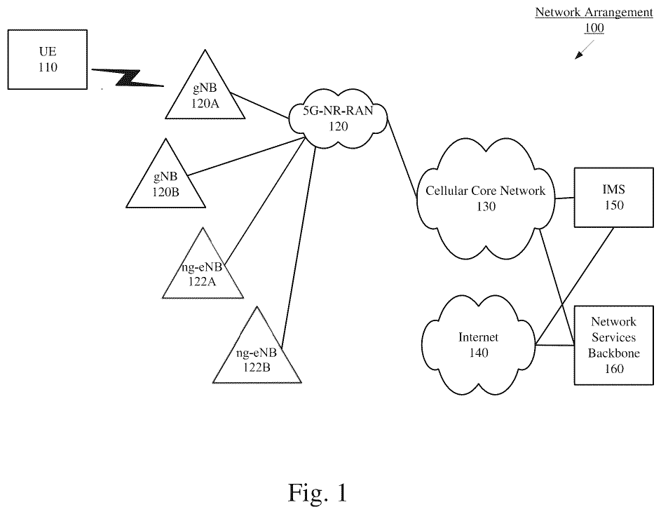

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., sixth generation (6G) RAN, a 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

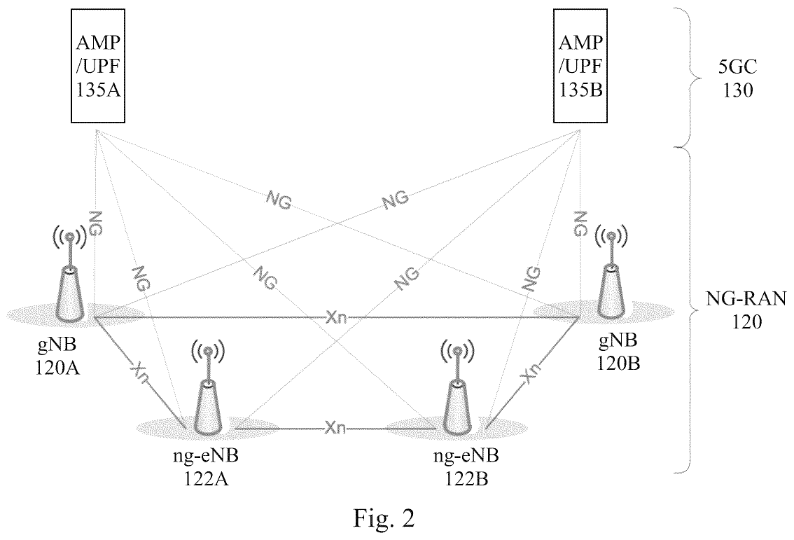

In this example, there are four base stations, gNB 120A, gNB 120B, ng-eNB 122A and ng-eNB 122B. Also, in this example, it may be considered that the core network 130 is the 5GC. Those skilled in the art will understand that an ng-eNB is a base station that allows a 5G UE to communicate with the 5GC using the LTE air interface. The operation and arrangement of the gNB 120A, gNB 120B, ng-eNB 122A and ng-eNB 122B will be described in greater detail below with reference to FIG. 2.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., gNB 120A, gNB 120B, ng-eNB 122A or ng-eNB 122B.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

FIG. 2 shows a further detailed view of an exemplary network arrangement 200 according to various exemplary embodiments. In this example, the network arrangement 200 shows the base stations gNB 120A, gNB 120B, ng-eNB 122A and ng-eNB 122B. In addition, the network arrangement 200 shows the access and mobility management function (AMF) and user plane function (UPF) as a combined entity AMF/UPF 135A and 135B of the 5GC 130.

The AMF performs operations related to mobility management such as, but not limited to, paging, non-access stratum (NAS) management and registration procedure management between the UE 110 and the 5GC 130. The UPF acts as an external PDU session point of interconnect to a data network (DN) and may perform packet routing and forwarding, perform packet inspection, enforce the user plane part of policy rules, lawfully intercept packets (UP collection), perform traffic usage reporting, perform QoS handling for a user plane (e. g., packet filtering, gating, UL/DL rate enforcement), perform Uplink Traffic verification (e.g., SDF to QoS flow mapping), transport level packet marking in the uplink and downlink, and perform downlink packet buffering and downlink data notification triggering. Reference to a two AMF/UPF 135A and 135B is merely for illustrative purposes, an actual network arrangement may include any appropriate number of AMFs and UPFs.

The gNBs 120A, 120B and ng-eNBs 122A, 122B are interconnected with each other by Xn interfaces. The gNBs 120A, 120B and ng-eNBs 122A, 122B are connected to the 5GC 130 (e. g., AMF/UPF 135A and 135B) by NG interfaces. As described above, an intra-5GC inter-RAT handover is from a gNB to an ng-eNB or from an ng-eNB to a gNB. For the handover between the NR-RAT and the LTE-RAT, the gNB provides the NR user plane and control plane protocol terminations towards the UE or the ng-eNB provides the E-UTRA user plane and control plane protocol terminations towards the UE. Both the Xn interface and the NG interface support inter-RAT handover between ng-eNB and gNB.

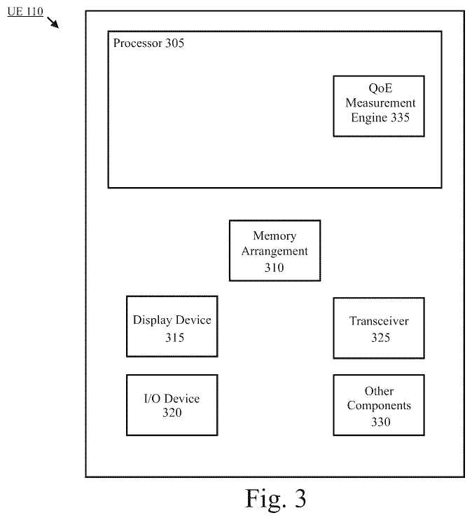

FIG. 3 shows an exemplary UE 110 according to various exemplary embodiments. The UE 110 will be described with regard to the network arrangement 100 of FIG. 1. The UE 110 may include a processor 305, a memory arrangement 310, a display device 315, an input/output (I/O) device 320, a transceiver 325 and other components 330. The other components 330 may include, for example, an audio input device, an audio output device, a power supply, a data acquisition device, ports to electrically connect the UE 110 to other electronic devices, etc.

The processor 305 may be configured to execute a plurality of engines of the UE 110. For example, the engines may include a QUE measurement engine 335. The QUE measurement engine 335 may perform various operations related to performing QoE measurements, reporting the QoE measurements to the network, and indicating support for QoE measurement configuration continuity during inter-RAT handovers. Each of these operations will be described in greater detail below.

The above referenced engine 335 being an application (e. g., a program) executed by the processor 205 is merely provided for illustrative purposes. The functionality associated with the engine 335 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 305 is split among two or more processors such as a baseband processor and an applications processor. The exemplary embodiments may be implemented in any of these or other configurations of a UE.

The memory arrangement 310 may be a hardware component configured to store data related to operations performed by the UE 110. The display device 315 may be a hardware component configured to show data to a user while the I/O device 320 may be a hardware component that enables the user to enter inputs. The display device 315 and the I/O device 320 may be separate components or integrated together such as a touchscreen. The transceiver 325 may be a hardware component configured to establish a connection with the 5G NR-RAN 120, an LTE-RAN (not pictured), a legacy RAN (not pictured), a WLAN (not pictured), etc. Accordingly, the transceiver 325 may operate on a variety of different frequencies or channels (e.g., set of consecutive frequencies).

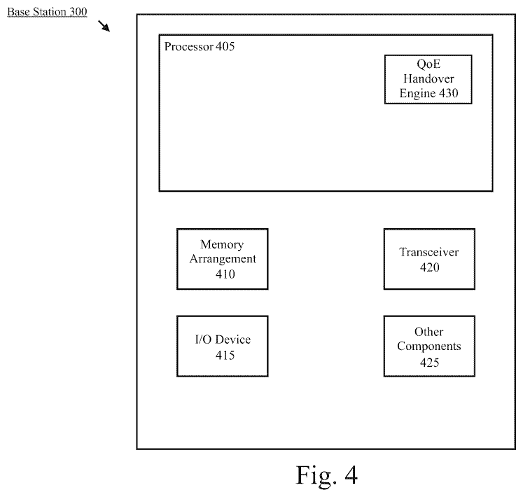

FIG. 4 shows an exemplary base station 400 according to various exemplary embodiments. The base station 400 may represent the gNB 120A, the gNB 120B, the ng-eNB 122A, the ng-eNB 122B or any other access node through which the UE 110 may establish a connection and manage network operations.

The base station 400 may include a processor 405, a memory arrangement 410, an input/output (I/O) device 415, a transceiver 420 and other components 425. The other components 425 may include, for example, an audio input device, an audio output device, a battery, a data acquisition device, ports to electrically connect the base station 400 to other electronic devices and/or power sources, etc.

The processor 405 may be configured to execute a plurality of engines for the base station 400. For example, a QoE handover engine 430 may perform various operations related to configuring a UE with a QoE configuration, determining whether a target/source cell supports QoE measurement continuity during inter-RAT handovers, exchanging QoE configurations with other base stations during inter-RAT handovers, etc. The operations described for the base station 400 may include operations that are performed when the base station is operating as a source base station or a target base station during a handover procedure. Each of these exemplary operations will be described in greater detail below.

The above noted engine 430 being an application (e.g., a program) executed by the processor 405 is only exemplary. The functionality associated with the engine 430 may also be represented as a separate incorporated component of the base station 400 or may be a modular component coupled to the base station 400, e.g., an integrated circuit with or without firmware. For example, the integrated circuit may include input circuitry to receive signals and processing circuitry to process the signals and other information. In addition, in some base stations, the functionality described for the processor 405 is split among a plurality of processors (e.g., a baseband processor, an applications processor, etc.) . The exemplary embodiments may be implemented in any of these or other configurations of a base station.

The memory 410 may be a hardware component configured to store data related to operations performed by the base station 400. The I/O device 415 may be a hardware component or ports that enable a user to interact with the base station 400. The transceiver 420 may be a hardware component configured to exchange data with the UE 110 and any other UE in the network arrangement 100. The transceiver 420 may operate on a variety of different frequencies or channels (e. g., set of consecutive frequencies). Therefore, the transceiver 420 may include one or more components (e.g., radios) to enable the data exchange with the various networks and UEs.

Prior to discussing the handover operations, the design of the various QoE signaling in the Uu interface is described. Initially, the NR QoE signaling design in the Uu interface is described. The network (e.g., 5GC 130) provides the QoE configuration to the UE 110 via the AppLayerMeasConfig in a RRCReconfiguration message. Multiple QoE configurations may be provided at the same time. The UE 110 may provide the QoE report to the network via an RRC message, e. g., MeasurementReportAppLayer. This message may be transmitted using the signaling radio bearer 4 (SRB4). During intra-NR handover, the UE 110 continues the ongoing measurements unless the network indicates to the UE to release the QoE configuration in the handover command.

Turning to the LTE QoE signaling design in the Uu interface, the network (e.g., 5GC 130) provides the QoE configuration to the UE 110 via the measConfigAppLayer in the RRCReconfiguration message. For LTE, only one QoE configuration can be provided. The UE 110 provides the QoE report to the network via the MeasReportAppLayer RRC message. It is also transmitted via the SRB4. During intra-LTE handover, the UE 110 continues the ongoing measurements unless the network indicates to the UE 110 to release the QoE configuration in the handover command.

As described above, currently the NR and LTE QoE mechanism support the continuity during intra-RAT handover, and do not support the inter-RAT handover case. The QoE information is not carried during the Xn and NG message during the handover between ng-eNB and gNB. Currently, when the UE 110 performs the inter-RAT handover, the UE 110 will stop and release the QoE configuration in the source RAT, and the QoE measurement continuity is not supported.

In contrast, the exemplary embodiments support QoE continuity for the intra-5GC inter-RAT handover procedure. In the exemplary embodiments, the QoE information is carried during the handover preparation procedure via the Xn and NG handover message between ng-eNB and gNB. In the exemplary embodiments, the ng-eNB and gNB are aware of the QoE configuration in the other RAT. Currently, the NR and LTE QoE messages in the Uu interface are different. Some exemplary embodiments provide support for intra-5GC inter-RAT handover QoE continuity without changing the existing Uu interfaces. However, in other exemplary embodiments, the Uu QoE configuration and reporting are changed to have a compatible design. Each of these aspects of the exemplary embodiments are described in greater detail below.

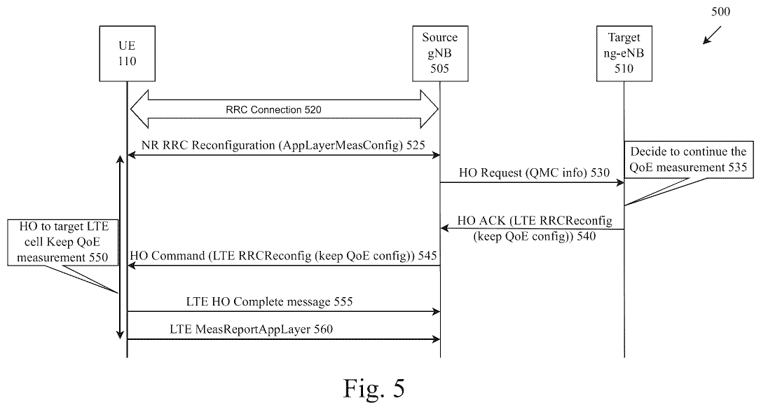

FIG. 5 shows an exemplary call flow 500 for an intra-system inter-RAT handover with QoE continuity according to various exemplary embodiments. The call flow includes the UE 110, a source gNB 505 (e.g., the gNB 120A or 120B) and a target ng-eNB 510 (e. g., the ng-eNB 122A or 122B). In this example, it may be considered that the handover is from the source gNB 505 to the target ng-eNB 510. However, it should be understood that the handover may also take place in the other direction, e.g., the ng-eNB 510 to the gNB 505.

In 520, it may be considered that the UE 110 is in an RRC Connected state with the source gNB 505. In 525, the UE 110 and the source gNB 505 may exchange signaling to configure the UE 110 for QoE measurements and reporting. In 530, the source gNB 505 sends a handover request to the target ng-eNB 510. The handover request may include QoE measurement configuration (QMC configuration) information element (IE). As will be described in greater detail below, in the exemplary embodiments, the network interface will support the QMC configuration exchange between the source gNB 505 and the target ng-eNB 510 in both the Xn and NG handover procedure.

In 535, the target ng-eNB 510 decides to continue the QoE measurements configured in source node after the handover. Thus, in 540 the target ng-eNB 510 sends a handover acknowledgment to the source gNB 505 indicating the target ng-eNB 510 will keep the partial or full of the source QoE configuration(s) after the handover. In 545, the source gNB 505 sends a handover command to the UE 110 including the LTE RRC reconfiguration message indicating that the QMC configured in source node will remain active after the handover.

In 550, the UE will be configured to keep the QMC active after the handover. As will be described in greater detail below, in the exemplary embodiments, the Uu interface will support a compatible design of the QUE configuration between LTE RRC and NR RRC, and support the UE 110 operation to continue the QOE measurement during the handover.

In 555, the UE 110 will send a handover complete message to the source gNB 505. The UE 110 will then continue to perform the QoE measurements when connected to the target ng-eNB 510 and, in 560, will report the QoE measurements to the target ng-eNB 510.

As described above, one of the issues that needs to be solved for the intra-5G inter-RAT handover is support for the QMC configuration information transmission between the gNB and the ng-eNB. The following will provide various solutions to this issue that may be implemented in the exemplary embodiments.

In some exemplary embodiments, the inter-RAT QMC continuity capability may be exchanged between the ng-eNB and the gNB. For example, when the node (e.g., ng-eNB or gNB) is setup, the node can inform the neighbor about as to the capability concerning the inter-RAT QOE continuity. If both the source and target nodes support the capability, the source node can include the QMC info in the handover request to the other node.

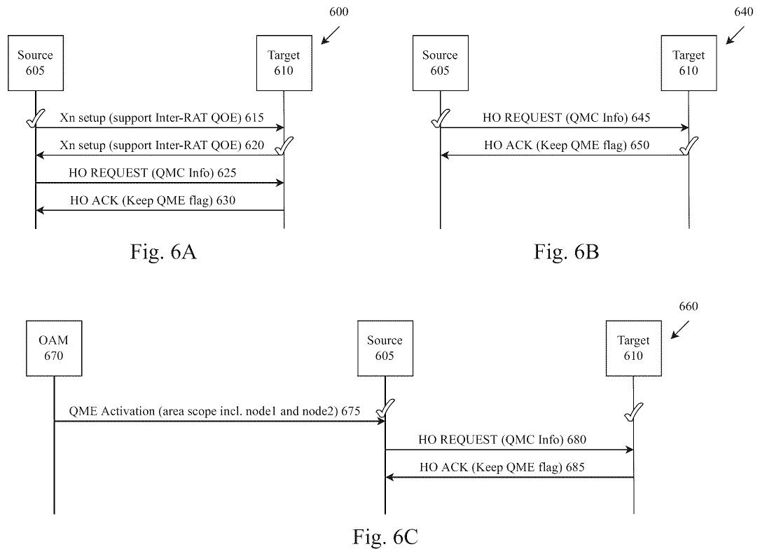

FIG. 6A shows an example call flow 600 for a source node 605 and target node 610 to exchange inter-RAT QMC continuity capabilities during node setup according to various exemplary embodiments. In the example of FIG. 6A and in the further examples of FIGS. 6B-C, it may be considered that the source node 605 is either a gNB or an ng-eNB and the target node is the other one of a gNB or an ng-eNB. For example, the source node 605 may be the gNB 120A and the target node 610 may be the ng-eNB 122A. In another example, the source node 605 may be the ng-eNB 122B and the target node 610 may be the gNB 120A.

As described above, in these exemplary embodiments, the source node and the target node share their respective inter-RAT QMC continuity capability during node setup. Thus, in 615, during setup, the source node 605 may send an Xn setup message that includes the inter-RAT QMC continuity capability of the source node 605. The target node 610, in 620 during setup, may send an Xn setup message that includes the inter-RAT QMC continuity capability of the target node 610.

In this example, it may be considered that both the source node 605 and the target node 610 support inter-RAT QMC continuity. Thus, at a later time, when the source node 605 is sending a handover request 625 to the target node 610, the source node 605 understands that the target node 610 supports inter-RAT QMC continuity and therefore may include the QMC information in the handover request 625. Similarly, when the target node 610 sends the handover acknowledgement 630, the target node 610 understands that the source node 605 supports inter-RAT QMC continuity and therefore can decide to continue with the QoE measurements and report this in the handover acknowledgement 630.

In other exemplary embodiments, the source node may directly include the QMC info in the handover request to the target node. That is, the source node may not have any preexisting knowledge of whether the target node supports inter-RAT QMC continuity. If the target node supports the inter-RAT QoE continuity and decides to enable this feature, the target node can include the QoE configuration or the continue indication in the handover acknowledgement message and in the configuration of the target node for handover.

FIG. 6B shows an example call flow 640 for a source node 605 and target node 610 to exchange handover information related to inter-RAT QMC continuity capabilities according to various exemplary embodiments. As described above, in these exemplary embodiments, the source node 605 may directly include the QMC info in the handover request 645 to the target node 610 without any preexisting knowledge of whether the target node 610 supports inter-RAT QMC continuity.

In this example, it may be considered that the target node 610 supports inter-RAT QMC continuity and decides to continue with the QoE measurements after the handover. Thus, in 650, the target node 610 sends a handover acknowledgment message that includes the QoE configuration or the continue indication.

In still further exemplary embodiments, the source node and the target node understand the inter-RAT QMC continuity capabilities of other nodes based on an Operations, Administration and Maintenance (OAM) configuration that is received by the source node and the target node. The OAM is a network function that may be used to provision and manage nodes within the network.

The OAM configuration may include an area cea so scope of the QOE measurement configuration. For example, the OAM configuration may provide a node ID list of nodes that support the inter-RAT QoE mobility continuity to each of the nodes in the area scope. Based on the information, the source node can decide whether to include the QMC information in the handover request message to the target node.

FIG. 6C shows an example call flow 660 for a source node 605 and target node 610 to receive an OAM configuration related to inter-RAT QMC continuity capabilities according to various exemplary embodiments. In addition to the source node 605 and target node 610, the call flow 660 also includes the OAM 670.

As described above, the OAM 670 will send the OAM configuration to the source node 605 in 675. The OAM configuration may include an area scope of the QOE measurement configuration, e.g., a node ID list of nodes that support the inter-RAT QoE mobility continuity. In this example, it may be considered that the OAM configuration indicates that the source node 605 and the target node 610 support the inter-RAT QoE mobility continuity. It should be understood that, while not shown in the call flow 660, the target node 610 will also receive the OAM configuration from the OAM 670 and will also understand that the source node 605 and the target node 610 support the inter-RAT QoE mobility continuity.

Thus, in 680, the source node 605 may send the handover request that includes the QMC information because the source node 605 has been preconfigured to understand that the target node 610 supports inter-RAT QoE mobility continuity. In 685, the target node 610 that has also been preconfigured to understand the source node 605 supports inter-RAT QoE mobility continuity, may send a handover acknowledgment indicating the target node desires the UE to continue QoE measurements after the handover.

As described above, another issue that needs to be solved for the intra-5G inter-RAT handover is either a compatible Uu design between LTE and NR for QoE RRC or a solution to handle the currently incompatible Uu designs. The following will provide various solutions to this issue that may be implemented in the exemplary embodiments.

In some exemplary embodiments, the LTE RRC on the QoE configuration and reporting may be enhanced. In these examples, NR and LTE may have a common RRC format that will allow the UE and the base station to understand the QoE configuration across RATS.

In these exemplary embodiments, the QMC configuration handling between the ng-eNB and gNB during the handover procedure is as follows. The target nodeB can select a QMC configuration based on the QMC configuration provided in the source nodeB. There may be various options for the target nodeB to provide an indication to the UE of the QMC configuration selected from the QMC configuration provided in the source nodeB. In a first option, the target nodeB may keep the previous QMC configuration. For example, the target nodeB may indicate to the source nodeB in the handover acknowledgement that the target nodeB would like to continue with the current QMC configuration that is being used by the UE for the source nodeB. Thus, the source nodeB, in the handover command to the UE, may provide an indication to continue with the current QMC configuration after the handover to the target nodeB.

In a second option, the target nodeB may indicate a full QMC configuration. For example, the target nodeB may indicate to the source nodeB a full QMC configuration in the handover acknowledgement. The source nodeB, in the handover command to the UE, may provide the full QMC configuration to the UE for the target nodeB.

In a third option, a delta QMC configuration may be indicated by the target nodeB to the UE. For example, the target nodeB may understand the current QMC configuration for the source nodeB. The target nodeB may then make changes to this current QMC configuration in the form of a delta configuration, e.g., a configuration showing the changes from the current QMC configuration. The source nodeB, in the handover command to the UE, may provide the delta QMC configuration to the UE for the target nodeB.

In these exemplary embodiments, a UE that supports the QoE measurement continuity during the inter-RAT handover will support the enhanced LTE RRC format of the LTE QoE configuration and report. That is, the UE will have new capabilities for the LTE QoE and the inter-RAT HO continuity. During the intra-5GC inter-RAT handover, the UE will understand the QMC configuration in the target nodeB based on the configuration in the handover command and the source QMC configuration. If the source QMC configuration is kept in the target nodeB, the UE continues the QOE measurements and reports the QoE measurement report generated in the source to the target nodeB.

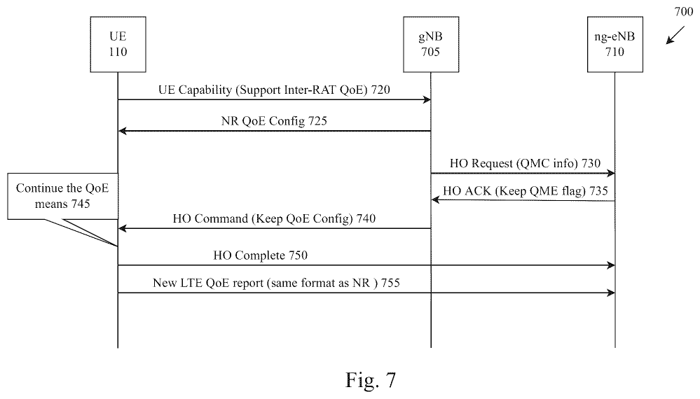

FIG. 7 shows an exemplary call flow 700 for an intra-system inter-RAT handover where both RATs have a compatible Uu radio resource control (RRC) design for QMC continuity capabilities according to various exemplary embodiments. The exemplary call flow 700 includes the UE 110, a gNB 705 and an ng-eNB 710.

In this example, it may be considered that the UE 110 supports the new LTE QoE capability, e.g., the UE 110 supports the common RRC format for NR and LTE with respect to the QMC configuration. Thus, in 720, the UE 110 reports this UE capability with respect to the QMC configuration for inter-RAT handovers to the gNB 705. In 725, the gNB 705 provides the UE 110 with the NR QMC configuration.

In 730, the gNB 705 sends a handover request to the ng-eNB 710 for the UE 110. The handover request may include the QMC information including that the UE 110 support the common RRC format for the QoE configuration. In 735, the ng-eNB 710 sends a handover acknowledgement to the gNB 705. The handover acknowledgment will include an indication as to whether the ng-eNB 710 wants the UE 110 to continue with the QoE measurements. If the ng-eNB 710 wants the UE 110 to continue with the QoE measurements, the handover acknowledgement 735 may also include the QMC configuration for the ng-eNB 710. As described above, this QMC configuration may include an indication for the UE 110 to keep the previous QMC configuration, to apply the full QMC configuration for the ng-eNB 710 or provides the UE 110 with a delta QoE configuration.

In 740, the gNB 705 sends the handover command to the UE 110 including the QMC configuration for the ng-eNB 710 (e.g., in any of the example forms described above). From the handover command, in 745, the UE 110 will understand whether to continue with the QoE measurements and, if yes, the QMC configuration of the ng-eNB 710.

In 750, the UE 110 will send a handover complete message to the ng-eNB 710. In 755, the UE 110 will send the LTE QoE measurement report to the ng-eNB 710. The LTE QoE measurement report will be the same as the NR QoE measurement report because, as stated above, in these exemplary embodiments, the UE 110 supports a common RRC format for the QoE configuration.

In other exemplary embodiments, the current LTE and NR RRC format for QoE configuration and reporting may be maintained. In these exemplary embodiments, one QoE configuration for the measurement continuity during the intra-5GC inter-RAT handover may be selected. As described above, only one configuration is supported in LTE, and multiple configurations are supported in NR. Thus, this needs to be accounted for when supporting the intra-5GC inter-RAT handover.

The following describes the operations of the network and the UE during the NR to LTE handover in these exemplary embodiments. If more than one QOE configuration is provided in NR, the source gNB selects one QoE configuration for continuity and forwards the selected QoE configuration to the target ng-eNB. There may be various options for selecting the one QoE configuration. In a first option, the first QoE configuration is selected. In a second option, any one of the QoE configurations may be selected. The selected QoE configuration may be based on the source gNB implementation. In a third option, the selected QoE configuration may be based on UE preference. For example, the UE may inform the network as to QoE configuration is to be kept during the inter-RAT handover to LTE. It should be understood that the first QoE configuration refers to a first QoE configuration that is in a list of multiple QoE configurations that are supported in NR.

With respect to the UE, when receiving the handover command including the NR QoE continuity information, the UE may keep the QoE configuration associated with the first QoE configuration or the network indicated QoE configuration ID, and provide the measurement reports to the ng-eNB.

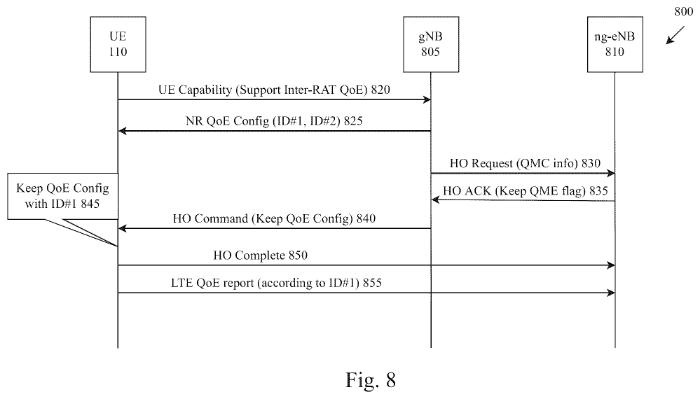

FIG. 8 shows an exemplary call flow 800 for an intra-system NR to LTE handover where the RATs do not have a compatible Uu radio resource control (RRC) design for QMC continuity capabilities according to various exemplary embodiments. The exemplary call flow 800 includes the UE 110, a gNB 805 and an ng-eNB 810. The exemplary call flow 800 is related to the exemplary embodiments of the NR to LTE handover described above.

In 820, the UE 110 reports the UE capability of support for QoE continuity for inter-RAT handovers to the gNB 805. In 825, the gNB 805 provides the UE 110 with the NR QMC configuration. As described above, the NR QMC configuration may include multiple QoE configurations. Thus, in this example, there are two exemplary QoE configurations identified with a QoE configuration ID #1 and QoE configuration ID #2.

In 830, the gNB 805 sends a handover request to the ng-eNB 810 for the UE 110. The handover request may include the QMC information including the selected QoE configuration. As described above, the selected QoE configuration may be the first QoE configuration (e.g., QoE configuration ID #1), any one of the available QoE configurations as may be selected by the gNB 805 or a QoE configuration based on the UE 110 preference as indicated to the gNB 805. In 835, the ng-eNB 810 sends a handover acknowledgement to the gNB 805. The handover acknowledgment will include an indication as to whether the ng-eNB 810 wants the UE 110 to continue with the QoE measurements.

In 840, the gNB 805 sends the handover command to the UE 110 including the selected QoE configuration for the ng-eNB 810 (e.g., as selected in any of the examples described above). From the handover command, in 845, the UE 110 will understand whether to continue with the QoE measurements and, if yes, the QoE configuration of the ng-eNB 810.

In 850, the UE 110 will send a handover complete message to the ng-eNB 810. In 855, the UE 110 will send the LTE QoE measurement report to the ng-eNB 810. In this example, the QoE configuration ID #1 was selected and the LTE QoE measurement report will be based on that QoE configuration. As also described above, there is no change to the LTE RRC format, so the LTE QoE measurement report will be the same as the current LTE QoE measurement report.

The following describes the operations of the network and the UE during the LTE to NR handover in these exemplary embodiments. The LTE node forwards the LTE QoE configuration to the target NR node, and NR node marks the LTE configuration as the first configuration ID or with a default configuration ID. The NR node may also add other new QoE configurations during the handover command at the same time.

With respect to the UE, when receiving the handover command with the LTE QoE continuity indication, the UE will continue to perform the LTE QoE measurements, and continue the QoE reporting in the target NR cell.

### EXAMPLES

In a first example, a processor of a base station operating as a source base station in an intra-system inter-radio access technology (inter-RAT) handover, wherein the base station communicates with a user equipment (UE) using a first RAT, the processor performing operations comprising configuring the UE with a quality of experience (QoE) configuration indicating QoE measurements and QoE reporting for the first RAT, sending, to a target base station, a handover request for the UE, wherein the handover request comprises a QoE measurement configuration (QMC) configuration information element (IE) comprising the QoE configuration, wherein the target base station communicates with the UE using a second RAT, receiving, from the target base station, a handover acknowledgement indicating the UE is to continue the QoE measurements and QoE reporting for the second RAT to the target base station after a handover from the source base station to the target base station is performed and sending, to the UE, a handover command comprising an indication the UE is to continue the QoE measurements and QoE reporting for the second RAT after the handover.

In a second example, the processor of the first example, wherein the source base station is a gNodeB (gNB) or an ng-evolvedNodeB (ng-eNB) and the target base station is an other one of the gNB or ng-eNB.

In a third example, the processor of the first example, wherein the operations further comprise sending, to the target base station, a first Xn message indicating the source base station supports intra-system inter-RAT QoE handover capabilities and receiving, from the target base station, a second Xn message indicating the target base station supports intra-system inter-RAT QoE handover capabilities.

In a fourth example, the processor of the first example, wherein the operations further comprise receiving, from an Operations, Administration and Maintenance (OAM) function of a core network, an OAM configuration indicating the target base station supports intra-system inter-RAT QoE handover capabilities.

In a fifth example, the processor of the first example, wherein the operations further comprise receiving, from the UE, an indication that the UE supports the UE supports QoE measurement continuity during the intra-system inter-RAT handover, and wherein the handover request further comprises an indication the UE supports the QoE measurement continuity during the intra-system inter-RAT handover.

In a sixth example, the processor of the first example, wherein the handover acknowledgement comprises a selection of a QoE configuration by the target base station for the UE to continue the QoE measurements, wherein the QoE configuration is a current QoE configuration being used by the source base station, a full QMC configuration or a delta configuration with respect to the current QoE configuration of the source base station.

In a seventh example, the processor of the sixth example, wherein the handover command further comprises the QoE configuration which will be applied in the target base station.

In an eighth example, the processor of the first example, wherein the source base station is a gNodeB (gNB) and the target base station is an ng-evolvedNodeB (ng-eNB), wherein the QoE configuration comprises a plurality of QoE configurations, and wherein the QMC configuration IE comprises a single one of the plurality of QoE configurations.

In a ninth example, the processor of the eighth example, wherein each of the plurality of QoE configurations is assigned a QoE configuration identification and the single one of the plurality of QoE configurations is one of (i) the QoE configuration having a first QoE configuration identification or (ii) any one of the plurality of QoE configurations.

In a tenth example, the processor of the eighth example, wherein the operations further comprise receiving, from the UE, an indication of a preference of the plurality of QoE configurations, wherein the single one of the plurality of QoE configurations is based on the preference.

In an eleventh example, the processor of the first example, wherein the source base station is an ng-evolvedNodeB (ng-eNB) and the target base station is a gNodeB (gNB) and wherein the QMC configuration IE comprises a single QoE configuration.

In a twelfth example, a base station comprises a transceiver configured to communicate with a user equipment (UE) and any of the processors of the first through eleventh examples communicatively coupled to the transceiver.

In a thirteenth example, a processor of a base station operating as a target base station in an intra-system inter-radio access technology (inter-RAT) handover, wherein the base station communicates with a user equipment (UE) using a first RAT, the processor performing operations comprising receiving, from a source base station, a handover request for the UE, wherein the handover request comprises a QoE measurement configuration (QMC) configuration information element (IE) comprising a QoE configuration, wherein the source base station communicates with the UE using a second RAT, sending, to the source base station, a handover acknowledgement indicating the UE is to continue QoE measurements and QoE reporting for the first RAT to the target base station after a handover from the source base station to the target base station is performed.

In a fourteenth example, the processor of the thirteenth example, wherein the source base station is a gNodeB (gNB) or an ng-evolvedNodeB (ng-eNB) and the target base station is an other one of the gNB or ng-eNB.

In a fifteenth example, the processor of the thirteenth example, wherein the operations further comprise receiving, from the source base station, a first Xn message indicating the source base station supports intra-system inter-RAT QoE handover capabilities and sending, to the source base station, a second Xn message indicating the target base station supports intra-system inter-RAT QoE handover capabilities.

In a sixteenth example, the processor of the thirteenth example, wherein the operations further comprise receiving, from an Operations, Administration and Maintenance (OAM) function of a core network, an OAM configuration indicating the source base station supports intra-system inter-RAT QoE handover capabilities.

In a seventeenth example, the processor of the thirteenth example, wherein the handover request further comprises an indication the UE supports the UE supports QoE measurement continuity during the intra-system inter-RAT handover.

In an eighteenth example, the processor of the thirteenth example, wherein the operations further comprise selecting a QoE configuration for the UE to continue the QoE measurements, wherein the selected QoE configuration comprises an indication to keep a current QoE configuration being used by the source base station, a full QMC configuration or a delta configuration with respect to the current QoE configuration of the source base station, wherein the handover acknowledgement further comprises the selected QoE configuration.

In a nineteenth example, the processor of the thirteenth example, wherein the target base station is an ng-evolvedNodeB (ng-eNB) and the source base station is a gNodeB (gNB) and, wherein the QUE configuration comprises a plurality of QoE configurations, and wherein the QMC configuration IE comprises a single one of the plurality of QoE configurations.

In a twentieth example, the processor of the nineteenth example, wherein each of the plurality of QoE configurations is assigned a QoE configuration identification and the single one of the plurality of QoE configurations is one of (i) the QoE configuration having a first QoE configuration identification or (ii) any one of the plurality of QoE configurations.

In a twenty first example, the processor of the thirteenth example, wherein the target base station is a gNodeB (gNB) and the source base station is an ng-evolvedNodeB (ng-eNB) and wherein the QoE configuration comprises a single QoE configuration.

In a twenty second example, the processor of the twenty first example, wherein the operations further comprise marking the single QoE configuration of the QMC configuration IE as a default QoE configuration.

In a twenty third example, the processor of the twenty first example, wherein the operations further comprise adding at least one additional QoE configuration to the single QoE configuration.

In a twenty fourth example, a base station comprises a transceiver configured to communicate with a user equipment (UE) and any of the processors of the thirteenth through twenty third examples communicatively coupled to the transceiver.

In a twenty fifth example, a processor of a user equipment (UE) is configured to perform operations comprising operating in a radio resource control (RRC) connected mode with a source base station, wherein the UE and the source base station communicate using a first radio access technology (RAT), receiving, from the source base station, a quality of experience (QoE) configuration indicating QUE measurements and QoE reporting for the first RAT, receiving, from the first base station, a handover command comprising an indication of a target base station to which the UE is to be handed over and that the UE is to continue the QoE measurements and QoE reporting for the second RAT after the handover, wherein the UE and the target base station communicate using a second RAT, sending, to the target base station, a handover complete message indicating the handover from the source base station to the target base station is complete, performing QoE measurements for the second RAT and reporting the QoE measurements to the target base station.

In a twenty sixth example, the processor of the twenty fifth example, wherein the source base station is a gNodeB (gNB) or an ng-evolvedNodeB (ng-eNB) and the target base station is an other one of the gNB or ng-eNB.

In a twenty seventh example, the processor of the twenty fifth example, wherein the operations further comprise sending, to the source base station, an indication that the UE supports a common radio resource control (RRC) format for the QoE configuration for the first RAT and the second RAT or the UE supports the QoE continuity during the intra-5GC inter-RAT handover.

In a twenty ninth example, the processor of the twenty fifth example, wherein the QoE configuration comprises an indication to keep a current QoE configuration being used by the source base station, a full QMC configuration or a delta configuration with respect to a current QoE configuration of the source base station.

In a thirtieth example, the processor of the twenty fifth example, wherein the source base station is a gNodeB (gNB) and the target base station is an ng-evolvedNodeB (ng-eNB), wherein the QoE reporting after the handover is based on a Long Term Evolution (LTE) QoE reporting.

In a thirty first example, the processor of the thirtieth example, wherein the QoE configuration for the source base station comprises a plurality of QoE configurations, and wherein the operations further comprise sending, to the source base station, an indication of a preference of one of the plurality of QoE configurations.

In a thirty second example, a user equipment (UE) comprises a transceiver configured to communicate with a source base station and a target base station, and any of the processors of the twenty fifth through thirty first examples communicatively coupled to the transceiver.

Those skilled in the art will understand that the above-described exemplary embodiments may be implemented in any suitable software or hardware configuration or combination thereof. An exemplary hardware platform for implementing the exemplary embodiments may include, for example, an Intel ×86 based platform with compatible operating system, a Windows OS, a Mac platform and MAC OS, a mobile device having an operating system such as ios, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method performed by a base station operating as a source base station in an intra-system inter-radio access technology (inter-RAT) handover, wherein the base station communicates with a user equipment (UE) using a first RAT, the method comprising:
configuring the UE with a quality of experience (QoE) configuration indicating QoE measurements and QoE reporting for the first RAT;
sending, to a target base station of a second RAT, a handover request for the UE, wherein the handover request comprises a QoE measurement configuration (QMC) configuration information element (IE) comprising the QoE configuration;
receiving, from the target base station, a handover acknowledgement indicating the UE is to continue the QoE measurements and QoE reporting for the second RAT to the target base station after a handover from the source base station to the target base station is performed; and
sending, to the UE, a handover command comprising an indication the UE is to continue the QoE measurements and QoE reporting for the second RAT after the handover.

2. The method of claim 1, wherein the source base station is a gNodeB (gNB) or an ng-evolvedNodeB (ng-eNB) and the target base station is an other one of the gNB or ng-eNB.

3. The method of claim 1, further comprising:
sending, to the target base station, a first Xn message indicating the source base station supports intra-system inter-RAT QoE handover capabilities; and
receiving, from the target base station, a second Xn message indicating the target base station supports intra-system inter-RAT QoE handover capabilities.

4. The method of claim 1, further comprising:
receiving, from an Operations, Administration and Maintenance (OAM) function of a core network, an OAM configuration indicating the target base station supports intra-system inter-RAT QoE handover capabilities.

5. The method of claim 1, further comprising:
receiving, from the UE, an indication that the UE supports QoE measurement continuity during the intra-system inter-RAT handover, and
wherein the handover request further comprises the indication the UE supports the QoE measurement continuity during the intra-system inter-RAT handover.

6. The method of claim 1, wherein the handover acknowledgement comprises a selection of a QoE configuration by the target base station for the UE to continue the QoE measurements, wherein the QoE configuration is a current QoE configuration being used by the source base station, a full QMC configuration or a delta configuration with respect to the current QoE configuration of the source base station.

7. The method of claim 1, wherein the source base station is a gNodeB (gNB) and the target base station is an ng-evolvedNodeB (ng-eNB),
wherein the QoE configuration comprises a plurality of QoE configurations, and
wherein the QMC configuration IE comprises a single one of the plurality of QoE configurations.

8. The method of claim 1, wherein the source base station is an ng-evolvedNodeB (ng-eNB) and the target base station is a gNodeB (gNB) and wherein the QMC configuration IE comprises a single QoE configuration.

9. A method performed by a base station operating as a target base station in an intra-system inter-radio access technology (inter-RAT) handover, wherein the base station communicates with a user equipment (UE) using a first RAT, the method comprising:
receiving, from a source base station, a handover request for the UE, wherein the handover request comprises a QoE measurement configuration (QMC) configuration information element (IE) comprising a QoE configuration, wherein the source base station communicates with the UE using a second RAT; and
sending, to the source base station, a handover acknowledgement indicating the UE is to continue QoE measurements and QoE reporting for the first RAT to the target base station after a handover from the source base station to the target base station is performed.

10. The method of claim 9, wherein the source base station is a gNodeB (gNB) or an ng-evolvedNodeB (ng-eNB) and the target base station is an other one of the gNB or ng-eNB.

11. The method of claim 9, further comprising:
receiving, from the source base station, a first Xn message indicating the source base station supports intra-system inter-RAT QoE handover capabilities; and
sending, to the source base station, a second Xn message indicating the target base station supports intra-system inter-RAT QoE handover capabilities.

12. The method of claim 9, further comprising:
receiving, from an Operations, Administration and Maintenance (OAM) function of a core network, an OAM configuration indicating the source base station supports intra-system inter-RAT QoE handover capabilities.

13. The method of claim 9, wherein the handover request further comprises an indication the UE supports the UE supports QoE measurement continuity during the intra-system inter-RAT handover.

14. The method of claim 9, further comprising:
selecting a QoE configuration for the UE to continue the QoE measurements,
wherein the selected QoE configuration comprises an indication to keep a current QoE configuration being used by the source base station, a full QMC configuration or a delta configuration with respect to the current QoE configuration of the source base station,
wherein the handover acknowledgement further comprises the selected QoE configuration.

15. The method of claim 9, wherein the target base station is an ng-evolvedNodeB (ng-eNB) and the source base station is a gNodeB (gNB) and,
wherein the QoE configuration comprises a plurality of QoE configurations, and
wherein the QMC configuration IE comprises a single one of the plurality of QoE configurations.

16. The method of claim 9, wherein the target base station is a gNodeB (gNB) and the source base station is an ng-evolvedNodeB (ng-eNB) and wherein the QoE configuration comprises a single QoE configuration.

17. A method performed by a user equipment (UE), comprising:
receiving, from a source base station of a first radio access technology (RAT), a quality of experience (QoE) configuration indicating QoE measurements and QoE reporting for the first RAT;
receiving, from the source base station, a handover command comprising an indication of a target base station of a second RAT to which the UE is to perform a handover and that the UE is to continue the QoE measurements and QoE reporting for the second RAT after the handover;
sending, to the target base station, a handover complete message indicating the handover from the source base station to the target base station is complete;
performing QoE measurements for the second RAT; and
reporting the QoE measurements to the target base station.

18. The method of claim 17, further comprising:
sending, to the source base station, an indication that the UE supports a common radio resource control (RRC) format for the QoE configuration for the first RAT and the second RAT or the UE supports the QoE continuity during the handover.

19. The method of claim 17, wherein the QoE configuration comprises an indication to keep a current QoE configuration being used by the source base station, a full QMC configuration or a delta configuration with respect to the current QoE configuration of the source base station.

20. The method of claim 17, wherein the source base station is a gNodeB (gNB) and the target base station is an ng-evolvedNodeB (ng-eNB), wherein the QoE reporting after the handover is based on a Long Term Evolution (LTE) QoE reporting.
